(19) United States
(12) Patent Application Publication
(10) Pub. No.: US 2019/0074670 A1
(43) Pub. Date: Mar. 7, 2019

(54) Modifying and Re-Coring a Cable

(71) Applicant: Deep Fiber Solutions, Inc., Roswell, GA (US)

(72) Inventors: Michael J. Crump, Roswell, GA (US); Michael K. Hebbard, Roswell, GA (US)

(21) Appl. No.: 16/120,873

(22) Filed: Sep. 4, 2018

Related U.S. Application Data
(60) Provisional application No. 62/553,531, filed on Sep. 1, 2017.

(51) Int. Cl. H02G 1/00; H01R 13/00; H01R 9/05; H01B 13/00; G02B 6/44

(52) U.S. Cl. CPC H02G 1/00; H01R 13/005; G02B 6/4479; H01B 13/0036; H01R 9/0521

(57) ABSTRACT

Methods of transforming a cable are disclosed herein, wherein the cable comprises an inner conductor and an insulator disposed around the inner conductor, and wherein some embodiments include heating the inner conductor to soften at least a portion of the insulator adjacent to the inner conductor, directing a fluid along the softened insulator and thereby creating a space between the inner conductor and the insulator along a length of the cable, injecting a lubricant into the space between the inner conductor and the insulator, and after creating the space between the inner conductor and the insulator, extracting the inner conductor from the cable.

### CROSS-REFERENCE TO RELATED APPLICATIONS

This application claims priority to U.S. Provisional Application 62/553,531 titled “Method for Modifying and Re-Coring a Cable,” filed on Sep. 1, 2017, the entire contents of which are incorporated herein by reference.

### SUMMARY

Homes, businesses, and other buildings or structures commonly include electrical cables disposed therein. One example cable is a coaxial or coax cable used to provide telecommunication services (e.g., television, voice, data, and perhaps other communication services). As the demand for new services grows, and as the bandwidth required (or at least desired) to support new and enhanced services increases, it may be desirable to upgrade the existing coaxial cable to optical fiber or other later developed signal transmission mediums.

That said, the existing cables at a given location may be secured within walls, flooring, and/or other structures, such that the cables are not easily accessible for replacement or upgrade. One proposed solution is to remove one or more portions of the existing cable, such as an inner core, and leaving an outer structure of the cable, and then to introduce the optical fiber, or other transmission medium, within the outer structure of the cable.

The present disclosure is directed generally to modifying and/or otherwise transforming an existing cable structure by removing a portion of the existing cable to create a space and replacing the removed portion with another transmission medium.

One example method is directed to transforming an elongate cable that includes at least a conductor and a protective layer disposed around the conductor. For instance, the cable includes an inner conductor and an insulator or dielectric surrounding the inner conductor. In this example, the method includes heating the inner conductor to thereby heat and soften at least a portion of the insulator adjacent to the inner conductor, and directing a fluid (liquid and/or gas) along the softened insulator to cool the insulator. This process of heating and cooling the insulator smooths or slickens the surface of the insulator, and also helps to separate or otherwise loosen the inner conductor from the insulator. In some embodiments, heating the inner conductor and directing fluid, liquid, and/or gas between the softened insulator and inner conductor creates a space along a length of the cable between the inner conductor and the insulator. Further, the method includes extracting the inner conductor from the cable after heating and cooling the insulator.

In some embodiments, the method further includes injecting or otherwise providing a lubricant into the space between the inner conductor and the insulator, and after providing the lubricant between the inner conductor and the insulator, extracting the inner conductor from the cable. This process of providing the lubricant between the inner conductor and the insulator facilitates the extraction of the inner conductor. In some examples, the lubricant is a dry lubricant and includes at least one of graphite and molybdenum disulfide (MoS₂). The processes of creating the space between the inner conductor and the insulator, and providing the lubricant into the space can be performed sequentially or concurrently.

While the inner conductor is being extracted, or thereafter, a new transmission line, such as an optical fiber, may be inserted into an area left by the extracted inner conductor. In some embodiments, the new transmission line includes an optical fiber. In some embodiments, the optical fiber may be around 900 microns in diameter, but fiber of other dimensions may be used without departing from the spirit of the present disclosure. Inserting the other transmission line can be performed, for example, by attaching one end of the transmission line to a first end of the inner conductor, and extracting the inner conductor by pulling, from a second end distal from the first end of the inner conductor, the inner conductor out of the insulator, which thereby pulls the new transmission line into the space vacated by the extracted inner conductor and surrounded by the insulator.

Attaching the end of the transmission line to the first end of the inner conductor includes, in some embodiments, forming an approximately 2° to 10° angled face with respect to the radial axis of the transmission line to increase an amount of surface area of the line that can be attached to the first end of the inner conductor, forming an approximately 2° to 10° angled face with respect to the radial axis of the inner conductor, and attaching the angled face of the end of the transmission line to the angled face of the first end of the inner conductor. Generally, the attachment between the transmission line and the inner conductor can be accomplished via an adhesive or soldering, for instance. Alternatively, a coupler can be crimped, glued or otherwise adhered to the transmission line and the inner conductor as well.

According to aspects disclosed herein, applying an electric current to the inner conductor heats the inner conductor to a temperature sufficient to soften at least a portion of the insulator closest to or adjacent the conductor along a length of the cable. When the cable is a common coaxial cable (for instance, a cable compliant with RG-6, RG-7, RG-11, R-59, or other cable specifications), the inner conductor is heated to between about 100° F. to 150° F. With this temperature range, the applied electric current may be between approximately 10 amperes to 25 amperes at approximately 1 volt to 50 volts under typical operating conditions. In one example, an electric current of approximately 15 amperes and a voltage that ramps up within a range of approximately 2 volts to 40 volts is used to heat the inner conductor to around 120° F. Other electrical conditions can be used, too, depending in part on the type and length of coaxial cable.

In some embodiments, directing the fluid, liquid, and/or gas along the softened insulator includes attaching a fitting to a first end of the cable and directing, through the fitting, compressed air between the inner conductor and the insulator. Example pressure levels of the compressed air are between about 400 pounds per square inch (psi) and 600 psi. In some embodiments, the same fitting or a different fitting is attached to the cable to couple the electric current to the inner conductor and/or to inject the lubricant between the inner conductor and the insulator.

In some embodiments, heating and subsequently cooling the insulator in the manner described herein to cause the inner diameter of the insulator to expand, effectively modifies or otherwise changes the dimensions or other surface characteristics of the insulator. Modifying the insulator in this manner facilitates easier removal of the inner conductor from the cable by creating space between the inner conductor and the insulator and/or by smoothing or slickening the surface of the insulator that is adjacent the inner conductor. This modification of the insulator is especially helpful when removing the inner conductor from coaxial cables that have been installed inside the walls of a structure (e.g., a home, apartment, building or other structure), because interior cables often have many more bends, twists, and turns based on their routing through walls and floors and around corners within a structure as compared to coaxial cable installed outside, which is typically buried in the ground or hung from a pole and tends to have longer, straighter runs as compared to interior cabling.

### SUMMARY OF THE FIGURES

FIG. 1 shows a partial isometric view of a cable according to some embodiments.

FIG. 2 is a flowchart showing a method according to some embodiments.

FIGS. 3A-3E illustrate partial isometric and block diagram views associated with the method of FIG. 2.

FIG. 4 illustrates a diagrammatic view of a connection or attachment between an inner conductor and a replacement transmission line according to some embodiments.

FIG. 5 illustrates a block diagram of an apparatus according to some embodiments.

FIG. 6 illustrates a fitting or connector according to some embodiment.

### DETAILED DESCRIPTION

The features described herein are set forth only as examples. As such, those skilled in the art will appreciate that other arrangements and elements (e.g., machines, interfaces, functions, orders, and groupings of functions) can be used instead, and that some elements or components may be omitted altogether. Further, the elements and components described herein may be functional entities that may be implemented as discrete or distributed components or in conjunction with other elements or components, and in any suitable combination and location.

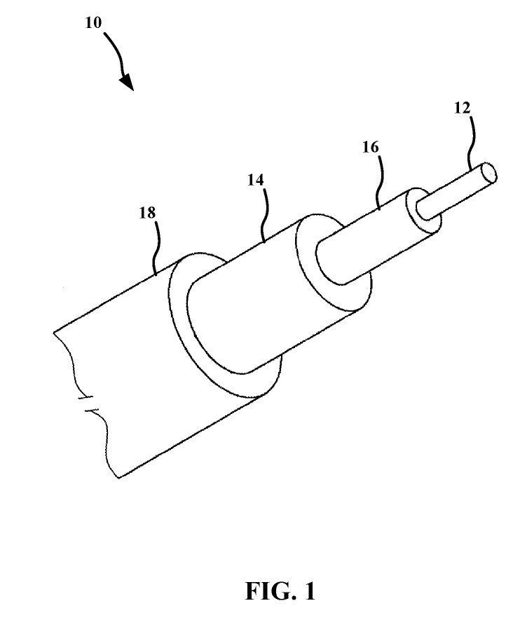

FIG. 1 shows an example cable 10 arranged in a coaxial configuration. The cable 10 includes a single solid or braided inner conductor 12. The inner conductor 12 is suspended in the center of a cylindrical tube or outer conductor 14 made of solid or braided conducting material, so that the inner conductor 12 runs axially along a centerline of an envelope of space within the outer conductor 14. The two conductors 12, 14 are separated physically and electrically from each other by an insulating dielectric material 16, which fills, or partially fills, an interstitial space between the inner conductor 12 and the outer conductor 14. The insulator or dielectric material 16 thereby provides physical support and electrical insulation in the cable 10. FIG. 1 further illustrates an outer protective sheath 18 that at least partially encapsulates the conductors 12, 14, and the insulator 16.

In the present example, the insulator 16 closely surrounds the inner conductor 12, and it may be bonded or bound to one or both of the conductors 12, 14. Thus, the inner conductor 12, the outer conductor 14, and the separating insulator 16 are maintained in alignment with and in close conjunction to one another. In such an arrangement, these elements of the cable 10 are substantially bonded together and cannot be easily dislodged or moved separately with respect to each other.

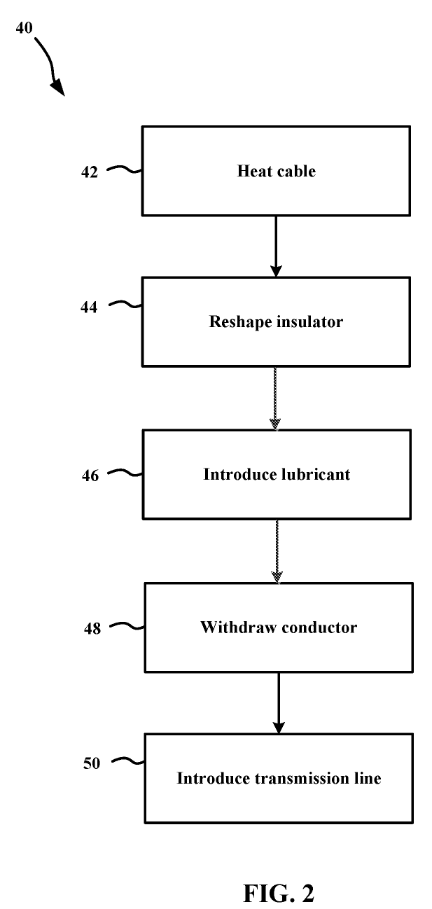

FIG. 2 shows an example method 40 for processing a cable, such as the coaxial cable 10, so that one or more elements of the cable can be dislodged or moved separately. At block 42, the cable is heated to help loosen the bonds between one or more of the cable elements, e.g., to help loosen the bonds between the inner conductor 12 and the insulator 16. In one embodiment, at block 42, the inner conductor is heated by applying an electric current through the inner conductor. In one example, the electric current is between about 10 amperes to 25 amperes at between about 1 volt to 50 volts. In another example, an electric current of approximately 15 amperes and a voltage that ramps up within a range of approximately 2 volts to 40 volts is used to heat the inner conductor to a desired temperature, e.g., around 120° F. Once the temperature of the inner conductor reaches the desired temperature, the electric current (and heating of the inner conductor) is stopped. Other electrical conditions can be used, too, depending in part on the type and length of coaxial cable.

Applying heat to the inner conductor, by electric current and/or other methods, results in a suitably uniform heating along the length of the inner conductor. This heating of the inner conductor also heats and thereby softens an adjacent portion of the insulator along an interface between the conductor and insulator, which thus facilitates release of the bond between the inner conductor and the adjacent insulator. Also, block 42 may additionally or alternatively include other processes to reduce, remove, or otherwise transform the insulator, such as using chemical compounds or a physical appliance to stretch, cut, or burn or melt away the insulating dielectric material 16.

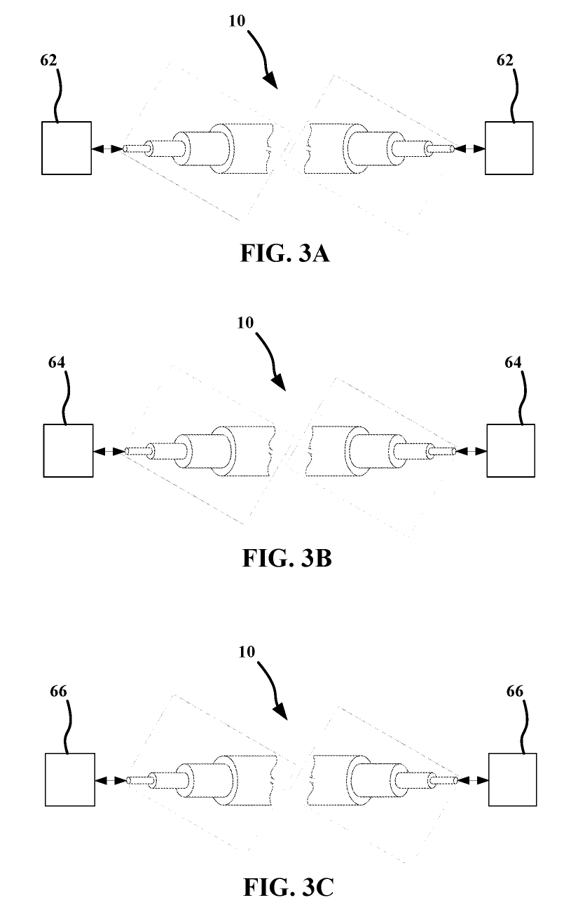

FIG. 3A illustrates an example configuration that includes a system 62 configured to heat the cable 10 (or at least the inner conductor therein), or otherwise soften or manipulate the insulator 16 within the cable 10. The system 62 includes a component coupled to each opposing end of a length of generally continuous cable to apply an electric current, chemical compound, and/or physical force to one or both of the inner conductor and/or insulator. Alternatively, the system 62 may include a component at only one end of the length cable.

In some embodiments, the system 62 applies an electric current through a first end of the inner conductor, while a distal second end of the inner conductor is coupled to ground or otherwise electrically coupled to allow the electric current to flow through the inner conductor. In these embodiments, the system 62 includes one or more components, such as a thermostat and/or a thermocouple, configured to monitor the temperature of the inner conductor and to control the electric current through the inner conductor based on the temperature of the inner conductor. In one example configuration, the thermostat and/or the thermocouple are coupled to the second end of the inner conductor. As discussed above, once the temperature of the inner conductor reaches a desired temperature, e.g., around 120° F. for common coaxial cables at room temperature, the electric current (and the heating of the inner conductor) is paused or interrupted.

Referring back to the method 40 (FIG. 2), at block 44, after the insulator is warmed and softened, the insulator is cooled and re-hardened. In one example, a fluid (liquid and/or gas) is injected or otherwise provided immediately when the inner conductor reaches the desired temperature (or reasonably quickly thereafter), and the fluid, liquid, and/or gas cools the insulator along the length of the cable. Some embodiments use air to cool the insulator. More particularly, some embodiments inject air (or another gas or liquid) at a pressure between about 400 to about 600 psi. Some embodiments include injecting air (or another gas or liquid) at an increasing pressure from between about 400 to 600 psi. The heating, cooling, and re-hardening functions to close a cell structure of the insulator, thereby smoothing or slickening the surface of the insulator adjacent the inner conductor. The heating, cooling, and re-hardening also functions to help create a small gap or division between the inner conductor and the surrounding insulator. The smoothing or slickening of the insulator surface alone or in combination with any small gap or division between the inner conductor and the surrounding insulator facilitates easier removal of the inner conductor from the cable.

FIG. 3B illustrates an example configuration that includes a system 64 configured to provide a fluid (or perhaps gas in some embodiments) to cool and/or otherwise reshape the insulator. The system 64 may include a component coupled to each opposing end of the length of cable to help facilitate injecting the cooling fluid through the length of the cable. The system 62 of FIG. 3A may be incorporated into a single apparatus with the system 64 of FIG. 3B. Alternatively, the system 62 and system 64 may be separate apparatuses.

Referring back to the method 40 (FIG. 2), at block 46, a lubricant is introduced in the gap between the inner conductor and the insulator. The lubricant can be a wet or dry lubricant. In some embodiments, example lubricants suitable for this purpose include graphite and/or molybdenum disulfide (MoS₂).

FIG. 3C illustrates an example configuration that includes a system 66 configured to provide the lubricant between the inner conductor and the insulator. The system 66 may include a component coupled to each opposing end of the length of cable to help facilitate introducing the lubricant through the length of the cable. In some embodiments, one or more of systems 62, 64, and 66 may be incorporated into a single apparatus. Alternatively, systems 62, 64, and 66 may be separate apparatuses.

Referring back to the method 40 (FIG. 2), at block 48, the inner conductor is extracted along its radial axis from the surrounding insulator. In some embodiments, the introduction of the lubricant at block 46 facilitates this extraction. In some embodiments, at block 48, the inner conductor is pulled from both ends of the cable to be sure of its readiness to be extracted out from one of the ends. Referring to FIG. 1, for example, after extraction of the inner conductor 12, the outer sheath 18, the outer conductor 14, and the insulator 16 remain with an open area or hollow space through the center of the cable where the extracted conductor 12 was previously located.

FIG. 3D illustrates an example configuration that includes a system 68 configured to clamp onto (or otherwise attaching to) at least one end of the inner conductor to then facilitate pulling and extracting the inner conductor from the insulator. In some embodiments, one or more of systems 62, 64, 66, and 68 may be incorporated into a single apparatus. Alternatively, systems 62, 64, 66, and 68 may be separate apparatuses.

Referring back to the method 40 (FIG. 2), at block 50, another signal conductor, such as an optical fiber signal conductor, or other signal transmission material or structure, is provided to replace the extracted inner conductor. In some embodiments, an optical fiber is attached to an end of the inner conductor, and as the inner conductor is pulled and extracted from the insulator, this pulls the optical fiber through the insulator into the space vacated by the inner conductor. Other examples for introducing the transmission material into the existing cable, either during or after the extraction of the inner conductor, are also contemplated as part of the disclosed embodiments. For example, in some embodiments, an optical fiber can be blown or pushed into the space vacated by the inner conductor after the inner conductor has been removed.

FIG. 3E illustrates an example configuration that includes a system 70 configured to introduce the signal transmission material (e.g., an optical fiber or other transmission media) into the space vacated by the extracted inner conductor. In some embodiments, one or more of systems 62, 64, 66, 68, and 70 may be incorporated into a single apparatus. Alternatively, systems 62, 64, 66, 68, and 70 may be separate apparatuses. In operation, system 70 comprises components arranged to extract the inner conductor from the cable while pulling the new transmission material (e.g., a fiber optic cable) into the space vacated by the extracted inner conductor.

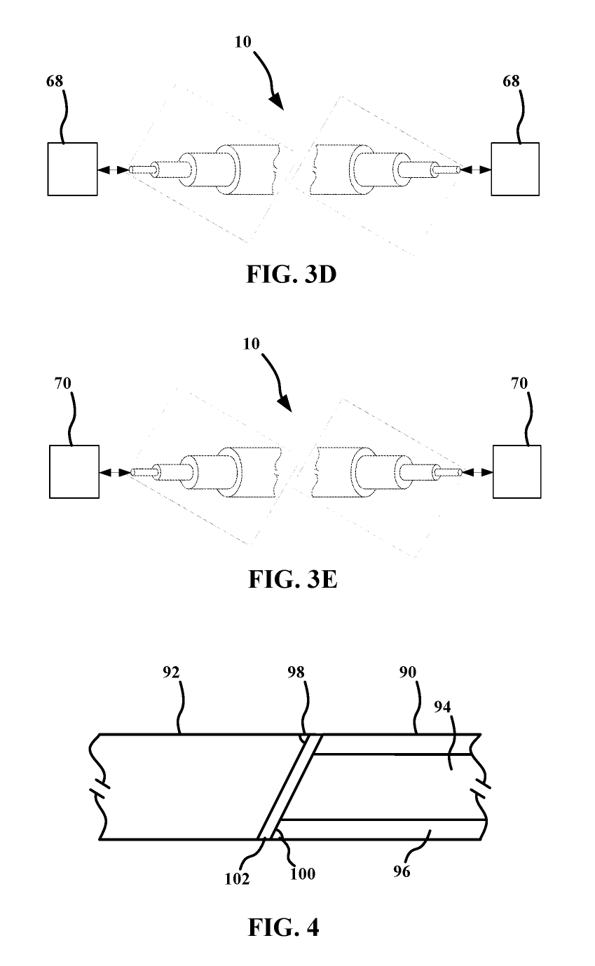

Further, FIG. 4 illustrates an example of a signal transmission material 90 attached to an end of an inner conductor 92. In operation, the inner conductor 92 is similar to or the same as inner conductor 12 of FIG. 1, and the new transmission material 90 is, for example, an optical fiber having an inner core 94 and a cladding layer 96 surrounding the inner core. In this example, one end of the new transmission material 90 (e.g., an optical fiber) is cut or ground to provide an angled face, which thereby increases an amount of surface area on a face of the new transmission material 90 that can be attached to a corresponding face of the inner conductor 92. For instance, in some embodiments, the end of the new transmission material 90 is formed to have an angle 98 of about 2° to about 10° with respect to a radial axis of the transmission material. One end of the inner conductor 92 is also cut or ground to provide an angled face, wherein the end of the conductor forms an angle 100 of about 2° to about 10° with respect to a radial axis of the inner conductor. The angled faces of the new transmission material 90 and the inner conductor 92 are then attached together using a suitable adhesive or other coupling compound or mechanism 102, for instance glue, soldering, mechanical clamps, and the like.

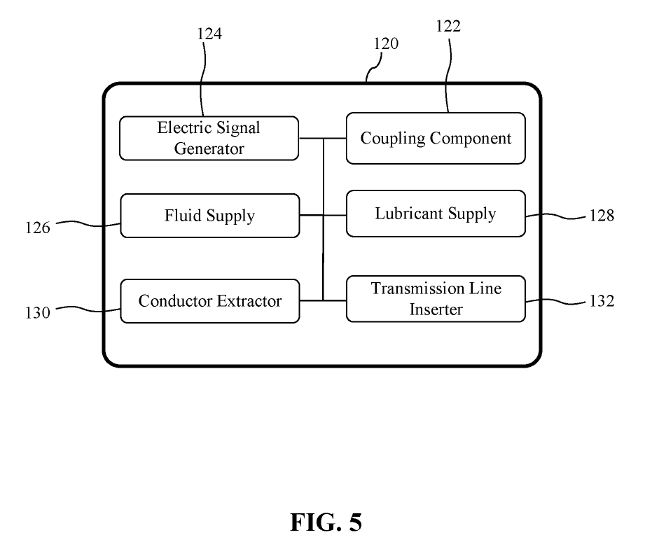

Referring to FIG. 5, a block diagram of an example apparatus 120 is shown, which is used to perform one or more of the processes of FIG. 2. In this example, the apparatus 120 includes a coupling component 122 (e.g., a fitting) configured to attach to an end of a cable, such as the cable 10 of FIG. 1. The apparatus 120 further includes an electric signal generator 124 configured to generate and apply an electric current to the cable through the fitting 122. In addition, the apparatus 120 includes a fluid supply 126 configured to inject or otherwise provide a fluid, liquid, and/or gas through the fitting 122 to cool the insulator along the length of the cable. The apparatus 120 also includes a lubricant supply 128 configured to introduce a lubricant through the fitting 122 and between the inner conductor and the insulator of the cable. Moreover, the apparatus 120 includes a conductor extractor 130 configured to clamp onto or otherwise attach to the inner conductor, and to aid in the extraction of the inner conductor through the fitting 122. And, the apparatus 120 includes a transmission line or material inserter 132 configured to introduce a new signal transmission material through the fitting 122 and into the space vacated by the extracted inner conductor.

The present disclosure contemplates that the various components 122-132 may be separate components of the apparatus 120 or combined in various ways. For instance, the fluid supply 126 and the lubricant supply 128 may be configured together such that the lubricant is provided along with the fluid, liquid, and/or gas. In another example, the conductor extractor 130 and the transmission line inserter 132 are configured together such that the extraction of the inner conductor and the insertion of the new transmission material are performed concurrently or at least substantially concurrently.

In some embodiments, the apparatus 120 provides a single apparatus that performs one or more of the processes of FIG. 2. Illustratively, the apparatus 120 is coupled to the cable via the coupling component 122 (e.g., a fitting), and through this coupling, one or more processes are performed, such as applying an electric current to the cable, providing a fluid, liquid, and/or gas to cool the insulator, introducing a lubricant between the inner conductor and the insulator, extracting the inner conductor, and/or inserting a new transmission material. In this manner, the process of modifying the cable is performed more quickly and efficiently without having to couple various different components to achieve the result of extracting the inner conductor and inserting a new transmission material. In other embodiments, however, the apparatus 120 may omit one or more of the components 122-132. For example, the conductor extractor 130 and/or the transmission line inserter 132 may be provided separately from the apparatus 120.

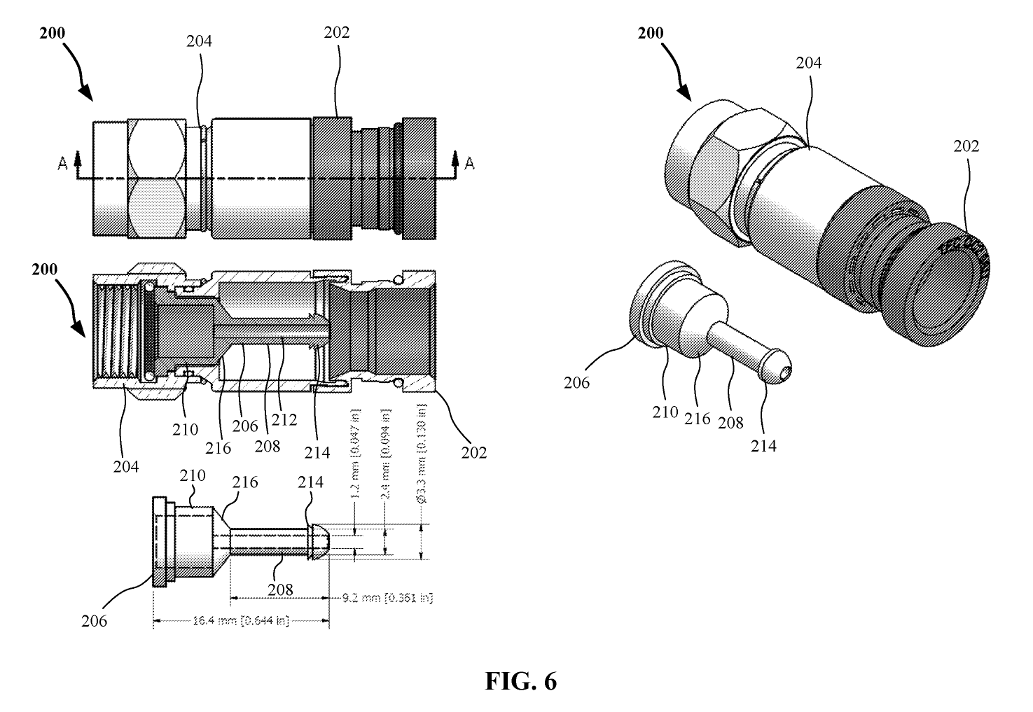

FIG. 6 illustrates a coupling component 200, which according to some embodiments is used as, or with, the coupling component 122 of FIG. 5. The coupling component 200 includes a compression fitting 202, a connector or sleeve 204 coupled to the compression fitting 202, and a fitting 206 configured to be disposed within at least a portion of the connector 204. In the component 200 of FIG. 6, the compression fitting 202, the connector 204, and the fitting 206 are generally annular in cross-section. Further, in this example, the connector 204 is a threaded female connector adapted to be coupled to a corresponding male connector. And, for instance, electricity, fluid, and/or lubricant are applied through the corresponding male connector and the female connector 204 to a cable, such as the cable 10 of FIG. 1.

The fitting 206 includes a post 208 extending from a base 210. An axial opening 212 defined through the post 208 is configured to fit snugly around the inner conductor of a cable. The post 208 is further configured to be inserted between the inner conductor and the insulator of the cable. A barb 214 at a distal end of the post 208 is configured to help maintain the post snugly on the end of a cable (between the inner conductor and the insulator). Example dimensions of the fitting 206 are identified in FIG. 6, although other dimensions could be used instead, depending on the type of coaxial cable the fitting 206 is to be used with. Further, the post 208 is made from an electrical conductor, such that an electric current can be applied through contact between the post 208 and the inner conductor of the cable. This arrangement is distinguishable from typical coaxial cable connectors, which are configured to electrically isolate the inner conductor from the rest of the connector.

In addition, a portion of the post 208 generally at a step 216 where the post 208 extends from the base 210 is made from an insulator or dielectric. Alternatively, a dielectric washer (e.g., a plastic washer) can be seated against the step 216. This insulator or dielectric portion helps to electrically isolate the outer conductor of the cable from the rest of the connector 200. This electrical isolation facilitates the application of electric current directly to the inner conductor to thereby heat the inner conductor and insulator, as discussed herein.

In use, an end of the cable is stripped away to leave a portion of the inner conductor extending from an end of the cable. The compression fitting 202 is disposed over the stripped end of the cable, and the post 208 is screwed or otherwise forced onto the end of the cable, such that the inner conductor of the cable extends through the opening 212 and the post 208 is fitted securely between the inner conductor and the insulator of the cable. In some embodiments, the compression fitting 202 is also crimped to help secure the coupling component 200 to the cable. In this manner, electric current can be applied through the post 208 to the inner conductor, and thereafter, fluid/lubricant can be directed between the inner conductor and the insulator of the cable via the coupling component 200.

The embodiments disclosed herein provide various potential benefits, including but not limited one or more of: (i) facilitating a more uniform release of bonds between an inner conductor and an insulator along a length therebetween; (ii) being effective for multiple different types of cable configurations (e.g., cables including solid or braided conductors); (iii) being able to start the processes from either end of a length of cable rather than being dependent (at least in part) on a direction of a winding in a cable with a braided configuration; (iv) not requiring a very specific pressure sealing of one or more ends of the cable; (v) not requiring the checking of tightness or permeability of the cable; and/or (vi) not relying on additives to the fluid used to separate the conductor and insulator.

While various aspects have been disclosed herein, other aspects will be apparent to those of skill in the art. The various aspects disclosed herein are for purposes of illustration only and are not intended to be limiting, with the true scope being indicated by eventual claims, along with the full scope of equivalents to which such eventual claims are entitled. It is also to be understood that the terminology used herein is for the purpose of describing particular example embodiments only, and is not intended to be limiting. For example, while the disclosed example embodiments focus on replacing a portion of a coaxial cable with optical fiber, the disclosed systems and methods may be equally applicable to other upgrade scenarios, such as upgrading an old fiber optical cable to a new fiber optic cable.

What is claimed is:

1. A method of transforming a cable, wherein the cable comprises an inner conductor and an insulator disposed around the inner conductor, and wherein the method comprises:
heating the inner conductor to soften at least a portion of the insulator adjacent to the inner conductor;
after heating the inner conductor to soften at least a portion of the insulator adjacent to the inner conductor, directing a fluid along the insulator and thereby creating a space between the inner conductor and the insulator along a length of the cable;
after directing the fluid along the insulator and creating the space between the inner conductor and the insulator along the length of the cable, injecting a lubricant into the space between the inner conductor and the insulator; and
after creating the space between the inner conductor and the insulator, extracting the inner conductor from the cable.

2. The method of claim 1, further comprising providing an optical fiber in a space vacated by the extracted inner conductor.

3. The method of claim 2, wherein providing the optical fiber comprises:
attaching an end of the optical fiber to a first end of the inner conductor; and
extracting the inner conductor by pulling, from a second end distal from the first end of the inner conductor, the inner conductor out of the insulator, thereby pulling the optical fiber into the space vacated by the extracted inner conductor.

4. The method of claim 3, wherein attaching the end of the optical fiber to the first end of the inner conductor comprises:
forming an approximately 2° to 10° angled face from its radial axis of the optical fiber to increase an amount of surface area of the fiber that can be attached to the first end of the inner conductor;
forming an approximately 2° to 10° angled face from its radial axis of the inner conductor; and
attaching the approximately 2° to 10° angled face from its radial axis of the optical fiber to the approximately 2° to 10° angled face from its radial axis of the inner conductor.

5. The method of claim 1, wherein heating the inner conductor includes applying an electric current to the inner conductor.

6. The method of claim 5, wherein the electric current is between 10 amperes to 25 amperes at between 1 volts to 50 volts.

7. The method of claim 1, wherein heating the inner conductor comprises heating the inner conductor to between 100° F. to 150° F.

8. The method of claim 1, wherein the fluid includes compressed air at about 400-600 psi.

9. The method of claim 1, wherein the lubricant comprises at least one of graphite or molybdenum disulfide (MoS₂).

10. An apparatus comprising:
a coupling component configured to attach to an end of a coaxial cable;
an electric signal generator configured to generate and apply an electric current to the coaxial cable through coupling component;
a fluid supply configured to inject or otherwise provide a fluid, liquid, and/or gas through the coupling component; and
a lubricant supply configured to introduce a lubricant through the coupling component between an inner conductor and an insulator of the coaxial cable.

11. The apparatus of claim 10, wherein the electric signal generator configured to generate and apply an electric current to the coaxial cable through coupling component is configured to generate and apply an electric current between about 10 amperes to 25 amperes at between about 1 volts to 50 volts to the inner conductor of the coaxial cable.

12. The apparatus of claim 10, wherein the electric signal generator configured to generate and apply an electric current to the coaxial cable through coupling component is configured to apply the electric current to the inner conductor of the coaxial cable, thereby heating the inner conductor to a temperature between about 100° F. to 150° F.

13. The apparatus of claim 10, wherein the fluid supply configured to inject or otherwise provide a fluid, liquid, and/or gas through the coupling component at a pressure of about 400-600 psi.

14. The apparatus of claim 10, wherein the lubricant comprises at least one of graphite or molybdenum disulfide (MoS₂).

15. A coupling component comprising:
an annular, semi-annual, cylindrical, or semi-cylindrical compression fitting;
an annular, semi-annual, cylindrical, or semi-cylindrical sleeve coupled to the compression fitting; and
an annular, semi-annual, cylindrical, or semi-cylindrical fitting configured to be disposed within at least a portion of the connector,
wherein the annular, semi-annual, cylindrical, or semi-cylindrical fitting further includes:
a post extending from a base, wherein the post is formed from an electrical conductor, and wherein a step portion between the post and the base is formed from an insulator;
an axial opening defined through the post, wherein the axial opening is configured to fit snugly around an inner conductor of a coaxial cable; and
a barb at a distal end of the post configured to maintain the post on an end of the coaxial cable, wherein the post is disposed between the inner conductor and an insulator surrounding the inner conductor.
